(19) United States
(12) Patent Application Publication
(10) Pub. No.: US 2011/0272836 A1
(43) Pub. Date: Nov. 10, 2011

(54) ECCENTRIC VESSELS

(75) Inventors: MARK J. KEEGAN, Groton, MA (US); Donna L. Kessel, Wayland, MA (US)

(73) Assignee: Selecta Biosciences, Inc., Watertown, MA (US)

(21) Appl. No.: 13/084,627

(22) Filed: Apr. 12, 2011

Related U.S. Application Data
(60) Provisional application No. 61/323,258, filed on Apr. 12, 2010.

(51) Int. Cl. B29B 9/12; B01F 15/06; B01F 3/08; B01F 7/00

(52) U.S. Cl. 264/5; 366/279; 366/145

(57) ABSTRACT

Vessels, including non-symmetric vessels for mixing fluids, are disclosed. In one aspect, the vessel is one that has a non-rotationally-symmetric interior surface. For example, the vessel may have an oblique frustoconical shape. At least a portion of the mixing vessel may have horizontal cross-sections having varying area, in some embodiments. The vessel may be formed from any suitable material, e.g., glass, plastic, or stainless steel. Such vessels may be used, according to certain embodiments, to create single, double or other multiple emulsions, for example, by exposing liquids or fluids contained therein to relatively high shear rates. In some cases, the vessel may be designed to be pharmaceutical-grade and/or meet ASME Bioprocessing Equipment (ASME-BPE) standards. For instance, the vessel may be used under conditions where the vessel is sterile, and/or the vessel may have a polished internal surface. In some cases, the vessel includes a temperature control system surrounding at least a portion of the vessel. Other aspects relate to methods of using such vessels, methods of creating or preparing such vessels, or kits involving such vessels.

### RELATED APPLICATIONS

This application claims the benefit under 35 U.S.C. §119 of U.S. provisional application 61/323,258, filed Apr. 12, 2010, the entire contents of which are incorporated herein by reference.

### FIELD

Aspects generally relate to vessels and, in particular, to eccentric or non-rotationally-symmetric vessels.

### BACKGROUND

Two or more liquids or other fluids may be mixed to form an emulsion. In some cases, an emulsion may be created by mixing liquids together in a vessel using high shear rates, for example, using high-speed rotational mixers. However, during such mixing, low shear regions within the vessel may cause problems with emulsification, e.g., if relatively homogenous emulsions are desired. In addition, in some cases, the creation of a vortex within the vessel may also create problems, for instance, due to excess air being introduced into a fluid, which could upset emulsion formation.

Typically, double emulsions are formed using two or more vessels having different working volumes, where the working volume in each vessel is the volume within the vessel taken up by the liquid. Two vessels are necessary because too much headspace within a single vessel (i.e., working volumes that are too low relative to the size of the vessel) can cause vortexing to occur, which creates problems such as inconsistent shear rates or excess air being introduced into the liquid. The vessels are typically rotationally symmetric, further facilitating vortex creation. Accordingly, to create double emulsions, two or more liquids are collected in a first mixing vessel and emulsified to create an emulsion, where the first vessel has a relatively high working volume and relatively little headspace, then the emulsion is transferred to a second mixing vessel where the emulsion is combined within a third liquid and emulsified to produce a double emulsion. Typically, the second vessel is selected to have a relatively high working volume and relatively little headspace, and the second vessel is usually bigger than the first vessel due to the need to introduce additional liquids in order to make the double emulsion. Two or more vessels are typically used since a single vessel for creating a double emulsion requires conflicting constraints: vessels with low working volumes are needed in order to have sufficient room within the vessel for all of the liquids used to make the emulsion; however, vessels with high working volumes are needed in order to reduce vortexing within the vessel.

Accordingly, improvements in the design of such vessels, e.g., to create emulsions or double emulsions, etc., are needed.

### SUMMARY

Aspects generally relate to vessels and, in particular, to eccentric or non-rotationally-symmetric vessels. In some cases, the vessels may be reducing eccentric vessels having varying horizontal cross-sectional areas. The subject matter involves, in some cases, interrelated products, alternative solutions to a particular problem, and/or a plurality of different uses of one or more systems and/or articles.

In one aspect, the invention is directed to a mixing apparatus. In one set of embodiments, the mixing apparatus comprises a vessel having a non-rotationally-symmetric interior surface, a rotational mixer positioned within the vessel, and a drive engaging the rotational mixer. In some cases, at least a portion of the mixing vessel has horizontal cross-sections having varying area. In certain instances, the drive is constructed and arranged to rotate the rotational mixer.

In another set of embodiments, the mixing apparatus comprises a vessel, where substantially horizontal cross sections of the vessel each define a shape having a center, where at least some of the centers are horizontally offset relative to other centers, and where at least some of the substantially horizontal cross sections have varying area. The mixing apparatus may also comprise a rotational mixer positioned within the vessel, and a drive engaging the rotational mixer. In some cases, the drive is constructed and arranged to rotate the rotational mixer.

In yet another set of embodiments, the mixing apparatus comprises a vessel having a base and a first portion that is perpendicular to the base, and a second portion diametrically opposed to the first portion that is not perpendicular to the base, a rotational mixer positioned within the vessel, and a drive engaging the rotational mixer. In some embodiments, at least a portion of the vessel has horizontal cross-sections having varying area. The drive, in some embodiments, may be constructed and arranged to rotate the rotational mixer.

In yet another set of embodiments, the mixing apparatus comprises a vessel, a rotational mixer positioned within the vessel, and a drive engaging the rotational mixer. In certain embodiments, at least a portion of the vessel has an oblique frustoconical shape. In some cases, the drive is constructed and arranged to rotate the rotational mixer.

In another aspect, the a method of making one or more of the embodiments described herein, for example, a non-symmetric vessel, is disclosed. In another aspect, a method of using one or more of the embodiments described herein, for example, a non-symmetric vessel, is disclosed.

Other advantages and novel features will become apparent from the following detailed description of various non-limiting embodiments when considered in conjunction with the accompanying figures.

### BRIEF DESCRIPTION OF THE DRAWINGS

Non-limiting embodiments will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment shown where illustration is not necessary to allow those of ordinary skill in the art to understand the embodiments discussed herein. In the figures:

FIGS. 1A-1D illustrate certain vessels useful for mixing fluids;

FIGS. 2A-2B illustrate various vessels having non-rotationally-symmetric interior surfaces, according to one embodiment;

FIGS. 3A-3D illustrate certain vessels having a substantially perpendicular portion, in another embodiment;

FIGS. 4A-4D illustrate vessels having first and second regions, in yet another embodiment;

FIG. 5 illustrates a vessel having first, second, and third regions, in still another embodiment;

FIG. 6 illustrates a mixing apparatus having a top and bottom head, in yet another embodiment;

FIG. 7 illustrates various vessels having non-rotationally-symmetric interior surfaces and varying horizontal cross-sectional areas, in accordance with still other embodiments; and

FIGS. 8A-8B illustrates two specific vessels in yet other embodiments.

### DETAILED DESCRIPTION

Vessels, including non-symmetric vessels for mixing fluids, are disclosed. In one aspect, the vessel is one that has a non-rotationally-symmetric interior surface. For example, the vessel may have an oblique frustoconical shape. At least a portion of the mixing vessel may have horizontal cross-sections having varying area, in some embodiments. The vessel may be formed from any suitable material, e.g., glass, plastic, or stainless steel. Such vessels may be used, according to certain embodiments, to create single, double or other multiple emulsions, for example, by exposing liquids or fluids contained therein to relatively high shear rates. In some cases, the vessel may be designed to be pharmaceutical-grade and/or meet ASME Bioprocessing Equipment (ASME-BPE) standards. For instance, the vessel may be used under conditions where the vessel is sterile, and/or the vessel may have a polished internal surface. In some cases, the vessel includes a temperature control system surrounding at least a portion of the vessel. Other aspects relate to methods of using such vessels, methods of creating or preparing such vessels, or kits involving such vessels.

Surprisingly, a single vessel may be used to produce a double emulsion, according to certain embodiments, avoiding issues such as those discussed above. Instead of creating a single emulsion in a first vessel, then transferring the emulsion to a second vessel (and potentially losing material during the transfer process), a double emulsion may be created using a single vessel, where a first liquid and a second liquid are emulsified within a vessel, then a third liquid added to the vessel and additional emulsification occurs to create the double emulsion. In particular, it would not be predictable that the use of a single vessel having a non-rotationally-symmetric interior surface and in some cases, horizontal cross-sections having varying area, could be used to create a double emulsion, as described herein. For instance, vessels such as those described herein may facilitate the initial creation of a single emulsion due to a relatively small cross-sectional area at the base of the device. In some cases, a relatively small volume of liquid within the vessel may nonetheless be sufficient to cover mixing elements within the vessel; the vessel also may have, in some cases, tapering sides and non-rotationally-symmetric interior surfaces, and a relatively large cross-section area at the top of the vessel (i.e., relative to the base of the vessel). The height of the vessel may also be selected to give the vessel adequate volume to create a double emulsion. Such a vessel may be useful in preventing vortex formation, and in some embodiments, it would be unexpected based on teachings within the prior art that a single vessel could be used to produce a double emulsion without requiring two or more separate vessels each separately selected to minimize vortexing. In addition, a single vessel may be advantageous for aseptic processing because the use of less equipment to clean or sterilize can reduce the risk of an aseptic breach.

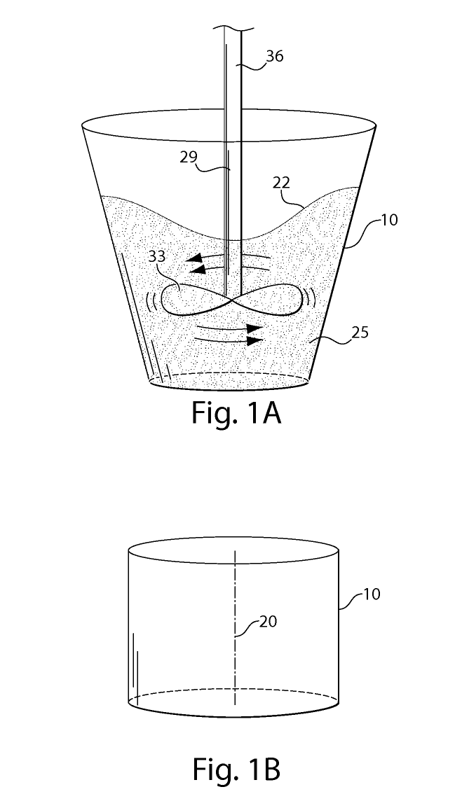

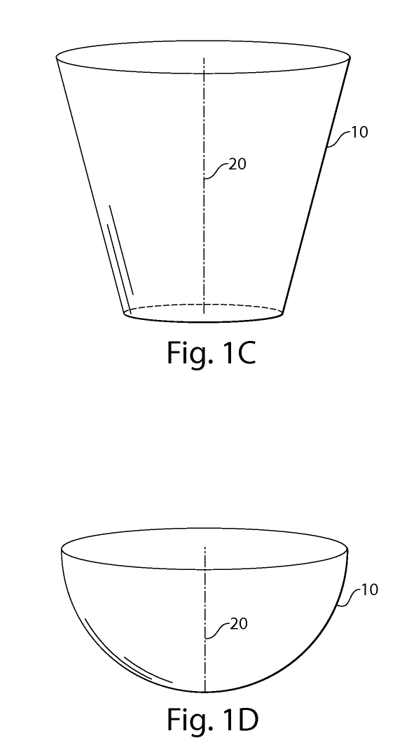

In one aspect, the mixing apparatus is designed to reduce or eliminate the creation of a vortex within a mixing vessel during fluid mixing. Without wishing to be bound by any theory, it is believed that such vortexes may be especially prominent in rotationally symmetric vessels, because fluids within rotationally symmetric vessels can move at relatively high speeds around the vessel without interruption during mixing using a rotational mixer, thereby causing pronounced vortex formation. A vortex may be formed during mixing in a mixing vessel as the fluid travels around the vessel due to the urging of a centrally-positioned rotational mixer. As a vortex is formed, the surface of the fluid may dip towards the centrally-positioned rotational mixer in a “funnel” or a “tornado” shape. This is depicted pictorially in the example shown in FIG. 1A, where vessel 10 contains a fluid 25 that has a vortex shape 22 caused by a centrally-positioned rotational mixer 29, including blades 33 and shaft 36. In this figure, vessel 10 is rotationally symmetric.

Higher rotational speeds of the rotational mixer may cause more pronounced vortex formation, although the exact shape of the vortex depends on factors such as the geometry of the mixing vessel, the fluidity, surface tension, or viscosity of the fluid within the mixing vessel, the speed at which the centrally-positioned rotational mixer is spun, or the configuration of the rotational mixer, e.g., the number and/or position of paddles, blades, rotors, or other mixer elements that are spun by the rotational mixer. In addition, fluid flow in a vortex is often turbulent, and the shape of the vortex can thereby fluctuate during mixing, especially at relatively high mixing speeds. However, a vortex shape can nevertheless be identified in the vessel by the dip of fluid around the rotational mixer caused when the rotational mixer is spun rapidly, relative to fluid levels in the vessel when the rotational mixer is not spun.

Vortex formation is undesirable in certain applications. For example, vortex formation may limit the degree or control of mixing of fluids within the vessel, which may result in poor, uneven, or heterogeneous mixing. For instance, in the formation of an emulsion such as is described herein, vortexing may result in a large or uneven distribution of sizes of discrete droplets of a first liquid contained within a second liquid. Vortex formation may also increase the exposure of the fluids to air, which may increase evaporation rate of the fluid or may have an undesirable effect on the chemicals dissolved in the fluid, such as denaturing proteins and causing precipitation. Vortex formation may also increase the amount of air entrained and/or dissolved in the fluid and decrease the fluid density and possible result in foaming. Accordingly, certain embodiments are directed to a mixing vessel able to reduce or eliminate vortex formation. Thus, a smaller vortex may be formed within the vessel due to the shape of the vessel, the positioning of mixers within the vessel, and/or due to internal elements within the vessel that at least partially break up vortex formation within the mixer. For example, the mixing apparatus may be designed to cause the creation of a non-rotationally-symmetric vortex, and/or in some cases, the mixing vessel may have an eccentric or non-rotationally-symmetric interior surface.

If the mixing vessel includes a non-rotationally-symmetric interior surface, it may define all, or only a portion, of the shape of the mixing vessel. A non-rotationally-symmetric surface is a surface of the mixing vessel that does not have an axis of rotation in which the mixing vessel can be rotated around such that the mixing vessel after rotation through any angle substantially coincides with the mixing vessel prior to rotation. Without wishing to be bound by any theory, it is believed that by using such mixing vessels having a non-rotationally-symmetric interior surface, fluids cannot symmetrically flow unobstructed around the interior of the vessel at constant speeds, and thus, vortex formation may be at least reduced during fluid mixing within such vessels.

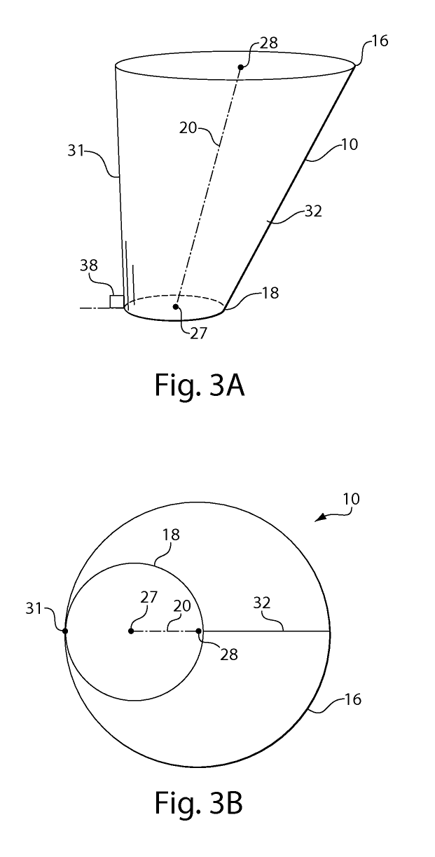

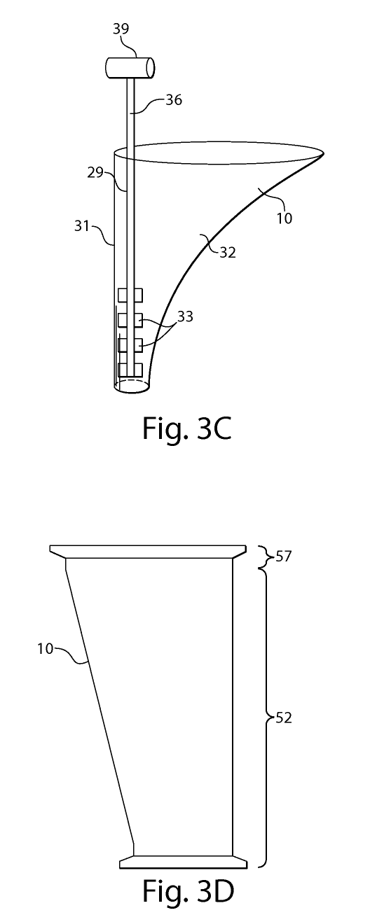

As mentioned, the non-rotationally-symmetric portion may be positioned within the vessel such that this portion of the vessel contacts the fluid during mixing, thereby allowing the non-rotationally-symmetric portion to reduce or eliminate vortex formation. For instance, the non-rotationally-symmetric portion may be positioned at the bottom of the vessel, such as is shown in FIG. 3D.

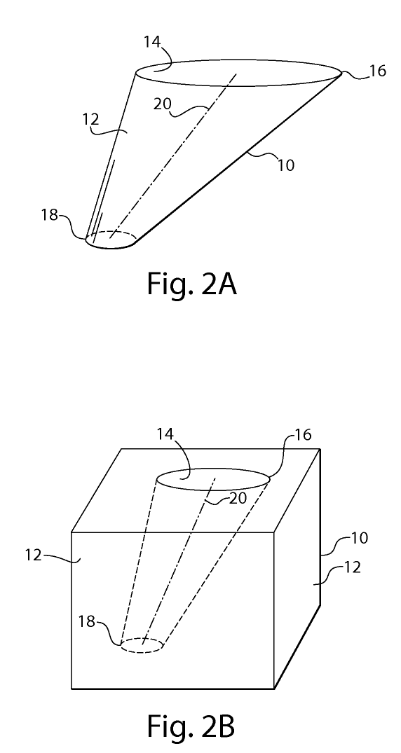

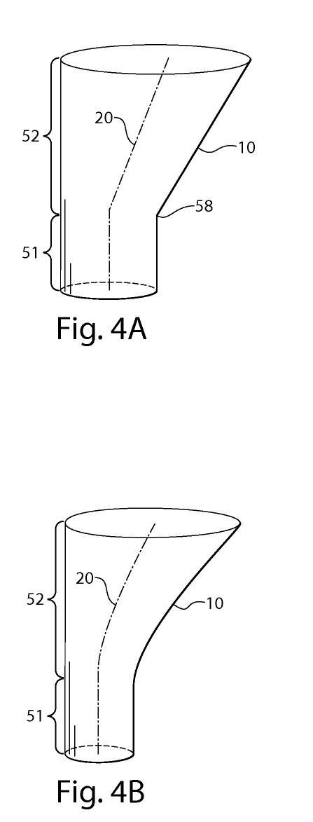

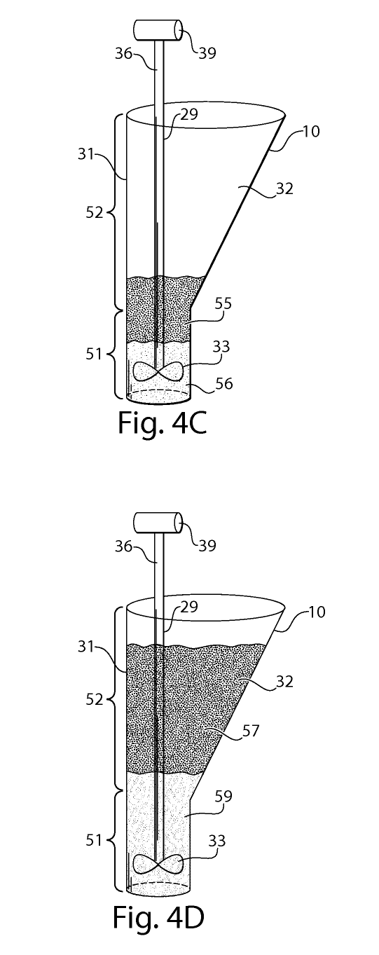

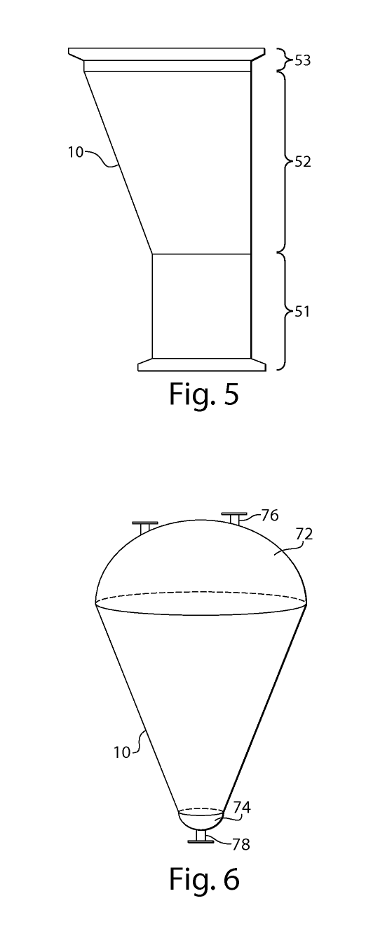

The portion of the mixing vessel which is non-rotationally-symmetric may vary, as is depicted in the figures. Likewise, the positioning of the non-rotationally-symmetric portion, when that portion is less than 100% of the volume of the mixing vessel, may vary, likewise as is depicted in the figures. For example, FIG. 3 shows an embodiment where the mixing vessel has a non-rotationally-symmetric interior from its bottom to its top, that is, covering 100% of its interior surface. In contrast, FIG. 4 shows an embodiment where the mixing vessel has a rotationally symmetric portion extending from the bottom and integral with a non-rotationally-symmetric portion beginning part way up and extending to the top of the interior surface. FIG. 5 shows a rotationally symmetric lower portion and a rotationally symmetric upper portion, joined by a non-rotationally-symmetric middle portion. Thus, it will be understood that the non-rotationally-symmetric portion may be all or only a portion of the interior surface of the mixing vessel. It will be further understood that the mixing vessel may comprise two or even more discrete non-rotationally-symmetric portions of different geometries, joined to one another (e.g., as depicted in FIG. 7), or separated by rotationally symmetric portions. As will be understood, the non-rotationally-symmetric portion may define, in horizontal cross sections, 100% of the interior volume of the mixing vessel, or at least about 95%, at least about 90%, at least about 85%, at least about 80%, at least about 75%, at least about 70%, at least about 65%, at least about 60%, at least about 55%, at least about 50%, at least about 45%, at least about 40%, at least about 35%, at least about 30%, at least about 25%, or even less of the interior volume of the mixing vessel. In some embodiments, the non-rotationally-symmetric portion may define, in horizontal cross sections, not more than about 95% of the interior volume of the mixing vessel, or not more than about 90%, not more than about 85%, not more than about 80%, not more than about 75%, not more than about 70%, not more than about 65%, not more than about 60%, not more than about 55%, not more than about 50%, not more than about 45%, not more than about 40%, not more than about 35%, not more than about 30%, not more than about 25%, not more than about 20%, or even less of the interior volume of the mixing vessel in some cases. In some embodiments, a non-rotationally-symmetric portion of a mixing vessel defines, in horizontal cross sections, at least about 50% of the interior volume of the mixing vessel and a rotationally symmetric portion defines, in horizontal cross sections, at least about 5%, at least about 10%, at least about 15%, at least about 20%, or at least about 25% of the interior volume of the mixing vessel. In some cases, the entire vessel is non-rotationally-symmetric, e.g., as is shown in FIG. 2A. In any of these vessels, during use, fluid at the bottom of the vessel is able to contact the non-rotationally-symmetric portions, thereby reducing or eliminating vortex formation.

In some cases, however, the non-rotationally-symmetric portion of the vessel may be positioned in a different portion of the vessel, i.e., in a position that does not contain the bottom of the vessel. However, the non-rotationally-symmetric portion may be positioned in the vessel such that, during use, fluid contacts the non-rotationally-symmetric portion so that the non-rotationally-symmetric portion is able to reduce or eliminate vortex formation during use of the vessel. For instance, the bottom of the vessel may contain a rotationally symmetric portion, with a non-rotationally-symmetric portion positioned above the rotationally symmetric portion. Thus, during use of the vessel, at least some fluid contacts the non-rotationally-symmetric portion, which facilitates the reduction or elimination of vortex formation within the vessel. See, e.g., FIGS. 4C and 4D, as discussed below. In one set of embodiments, the symmetric portion at the bottom of the vessel, positioned below the non-rotationally-symmetric portion, may contain at least about 5%, at least about 10%, at least about 15%, at least about 20%, at least about 25%, at least about 30%, at least about 35%, at least about 40%, at least about 45%, or at least about 50% of the total interior volume of the vessel. In some cases, the rotationally-symmetric portion, if present, may contain no more than about 60%, no more than about 55%, no more than about 50%, no more than about 45%, no more than about 40%, no more than about 35%, no more than about 30%, no more than about 25%, no more than about 20%, no more than about 15%, no more than about 10%, or no more than about 5%, of the total volume of the vessel.

A variety of definitions are now provided which will aid in understanding various aspects of the invention. Following, and interspersed with these definitions, is further disclosure that will more fully describe the invention.

As used herein, the term “fluid” generally means a material in a liquid or gaseous state. Fluids, however, may also contain solids, such as suspended or colloidal particles. In one set of embodiments, a fluid is an emulsion, e.g., comprising a first liquid and a second liquid, where the first liquid is present as discrete droplets (the “discontinuous” phase) within the second liquid (the “continuous” phase). In another set of embodiments, the fluid may contain a double emulsion or a higher-order multiple emulsion, e.g., as discussed below.

Typically, fluids in physical contact with each other in an emulsion are substantially immiscible. As used herein, two fluids are “substantially immiscible” with each other when one cannot be solubilized in the other to a concentration of at least 10% by weight when the fluids are left undisturbed in physical contact with each other under ambient conditions (e.g., at 25° C. and 1 atm) for at least an hour. In some embodiments, two fluids not in physical contact with each other are miscible, while an intervening fluid is immiscible with each of the two fluids (for example, a first fluid and a third fluid may be miscible, while a second fluid separating the first and third fluids may be immiscible in each). In other embodiments, however, all three fluids may be mutually immiscible.

In certain cases, the fluids do not all necessarily have to be water-soluble (i.e., miscible in water). For example, a first fluid may be water-soluble, a second fluid may be water-insoluble (i.e., immiscible in water, sometimes termed the “oil” phase), and a third fluid may also be water-soluble. In another example, a first fluid may be water-insoluble, a second fluid may be water-soluble, and a third fluid may be water-insoluble. It should be noted that the term “oil” in this terminology merely refers to a fluid that is not miscible in water (i.e., the fluid is hydrophobic), as is known in the art. Thus, the oil may be a hydrocarbon in some embodiments (e.g., octane or benzene), but in other embodiments, the oil may comprise other hydrophobic fluids, for example, silicone oil or methylene chloride (CH₃Cl), which are not necessarily pure hydrocarbons. Similarly, a “water-soluble” liquid (also referred to as the “water” phase) may be pure water, an aqueous solution, or another liquid, such as ethanol, that is soluble or miscible in water. The aqueous or water phase may also contain one or more other species dissolved and/or suspended therein, for example, a salt solution, a saline solution, a suspension of water containing particles or cells, or the like. In some embodiments, additional fourth, fifth, sixth, etc. fluids may be added to produce increasingly complex droplets within droplets, e.g., a first fluid may be surrounded by a second fluid, which may in turn be surrounded by a third fluid, which in turn may be surrounded by a fourth fluid, etc., and any of these fluids may be relatively miscible or immiscible, so long as two fluids in physical contact with each other in the emulsion are substantially immiscible.

As used herein, “rotationally symmetric” means that the object defines at least one axis of rotation that, when the object is rotated about the axis of rotation (e.g., a center axis of rotation), the object has the same shape (i.e., “looks the same”) when rotated at any angle around the axis of rotation, i.e., the object can be superposed on top of itself without any significant discrepancies. (Minor discrepancies such as dents, scrapes, minor manufacturing defects, scratches, nicks, welds, etc. or minor features such as holes, ports, lips, spouts, mounts, external piping, etc., should be ignored when considering the shape of the object and whether it is rotationally symmetric or not.) Such rotationally-symmetric objects usually have circular cross-sections, when cleaved in a plane perpendicular to the axis of rotation. Examples of rotationally-symmetric vessels are shown by vessels 10 in FIGS. 1B-1D, with the axis of rotation 20 as marked. An object that is “non-rotationally symmetric” is one that does not satisfy the above-described definition of a rotationally-symmetric object. Typically, a non-rotationally-symmetric object has no available axis of rotation around which the object can be rotated through any angle of rotation and still retain the same shape, i.e., there is no available axis of rotation around which the object can be rotated and still be superposed on top of itself without any significant discrepancies.

The “interior surface” of a vessel is any surface that is present in the interior of the vessel, i.e., that portion of the vessel that can hold a liquid without losing any of it due to geometrical considerations (i.e., due to “holes” in the interior vessel, or due to the shape of the vessel; for example, the vessel may only have one opening at the top of the vessel). It should be noted that, as used herein, the interior surface does not include baffles, holes, ports, mounts, mixing blades, magnetic stirrers, or other structures mounted onto, passing through, or contained within the mixing vessel or its interior surface. The interior surface may, in some cases, be defined by the object defining the vessel (e.g., the sidewalls of the object forming the vessel, such as is shown in the example of FIG. 2A). However, in other cases, the interior surface need not have the same shape as an outer surface of the vessel, for example, due to wall thicknesses or other vessel elements, as is shown in the example of FIG. 2B. In some embodiments, as discussed in detail below, a portion of the mixing vessel may have a rotationally symmetric interior surface, although the entire interior surface may be non-rotationally-symmetric.

Non-limiting examples of mixing vessels having non-rotationally-symmetric interior surfaces are shown in FIGS. 2A-2B. The interior surface of the vessel need not necessarily have the same shape as the exterior surface of the vessel, although they may have the same shape in some cases. One example of a vessel having a non-rotationally-symmetric interior surface is shown in FIG. 2A. In FIG. 2A, vessel 10 includes an exterior surface 12, an interior surface 14, an open top 16, and a closed base 18. In this figure, exterior surface 12 and interior surface 14 have the same shape, although they may have different shapes in other embodiments, for example, as is shown in FIG. 2B with interior surface 14 and exterior surface 12 of vessel 10.

The examples of mixing vessels shown in FIGS. 2A and 2B both have an interior surface having an oblique frustoconical shape, as non-limiting examples of the shape of an interior surface. Another non-limiting example of a vessel having an oblique frustoconical shape is shown in FIG. 3A. “Oblique” means that at least a portion of the center axis of the vessel, as defined by its inner surface, is not perpendicular to the base of the vessel. This can be seen by axis 20 in FIG. 2A. The “center axis” of a vessel is defined herein using substantially horizontal cross sections of the vessel, each of which defines a shape having a center, and connecting each of the centers with a line (not necessarily straight), when the vessel is positioned such that the lowest portion of an open top of the vessel is at its maximum highest position away from the lowest point of the vessel, i.e., when the vessel is in a “standing” position. In some cases, the center axis may be curved or bent, e.g., in a vessel having a shape such as is shown in FIGS. 4A and 4B with axis 20. In an oblique vessel, as defined by its inner surface, some or all of the centers are horizontally offset relative to other centers when the vessel is in a standing position.

“Frustroconical” generally describes an object having the shape of a frustum of a cone, i.e., where the object has a portion that, if extended, would describe a cone; in other words, a frustroconical shape is produced by truncating a cone. A “cone” is a three-dimensional geometric shape that tapers, generally smoothly, from a flat base to a point or other shape having zero area (e.g., a line or an arc). A “cone” as used herein need not have perfectly circular cross-sections, although the cross-sections may be circular in some embodiments. In other embodiments, however, the cross-sections of the cone may be elliptical, oval, square, rectangular, triangular, rounded rectangular, irregular, or any other suitable shape. Non-limiting examples of vessels having oblique frustroconical interior surfaces are shown in FIGS. 2A and 2B.

As used herein, a mixing vessel defines a “center axis” by considering substantially horizontal cross sections of the mixing vessel, each of which defines a shape having a center.

The center axis is the locus of all such points, and usually runs from the base of the mixing vessel to its top. In particular, the shape of the center axis may be straight, bent, curved, etc., depending on the shape of the mixing vessel. For example, in some cases, some or all of the substantially horizontal cross sections of the mixing vessel may each define a circle, although the centers of the circles need not coincide, and in fact some or all of the centers may be offset relative to other centers. In other embodiments, the shapes defined by the substantially horizontal cross sections of the mixing vessel are not all circles, and may be other shapes, for example, ellipses, ovals, triangles, squares, polygons, irregular shapes, etc. In some embodiments, the centers of some or all of the substantially horizontal cross sections may coincide vertically (e.g., defining a vertical center axis), although in other embodiments, some or all of the centers may be offset relative to other centers. For example, in one set of embodiments, the center axis is not a vertical line, which can indicate that the mixing vessel is one that is not rotationally symmetric. Other examples of mixing vessels having non-rotationally-symmetric interior surfaces and varying horizontal cross-sectional areas are shown in FIG. 7. A vessel having a “varying horizontal cross-sectional area” will have, at least, a first portion having a first horizontal cross-section area and a second portion having a second horizontal cross-section area. In one set of embodiments, the vessel may have smoothly varying horizontal cross-sectional area. In another set of embodiments, however, the vessel may have a first region having a first, constant horizontal cross-sectional area, and a second region having a second, constant horizontal cross-sectional area that is not equal to the first area. In some cases, the difference in area is at least about 5%, at least about 10%, at least about 20%, etc., relative to the smaller of the two areas. The change in area within the vessel from the first horizontal cross-section to the second horizontal cross-section may be abrupt or gradual (i.e., the vessel “tapers” from a first area to a second area). In some cases, the change between the first horizontal cross-section and the second horizontal cross-section may be linear. In some cases, the vessel may be a “reducing” vessel, i.e., the areas of the horizontal cross-sections may stay the same or decrease going from the top of the vessel towards its base, without any increases.

In one set of embodiments, the mixing vessel may be shaped such that substantially all of the horizontal cross-sections of the mixing vessel are different, e.g., the mixing vessel tapers smoothly from a first area to a second area, for example, as is shown in the vessels in FIG. 2A or 3C. In other embodiments, however, the change in area is abrupt. In some instances, the vessel may include a first portion or region that exhibits varying horizontal cross-section areas and a second portion or region that does not exhibit varying horizontal cross-section areas, for instance, as is shown in FIG. 4A with vessel 10 having a first region 51, and a second region 52. In this example, first region 51 does not exhibit varying horizontal cross-section areas, while second region 52 does exhibit varying horizontal cross-section areas. In some embodiments, such as is shown in FIG. 3C, the areas of the horizontal cross-section areas may smoothly decrease or be reduced from a first, larger area at the top to a second, smaller area at the base of the vessel.

In one set of embodiments, the mixing vessel may have an interior wall or portion that is substantially perpendicularly oriented. For example, when the vessel is in a standing position, the vessel has an interior wall or portion that is substantially perpendicularly oriented, i.e., in a vertical direction. The orientation may be determined relative to the base of the vessel, e.g., when the vessel is in a standing position. It should be noted that the entire mixing vessel need not be substantially perpendicularly oriented (e.g., as is shown in FIG. 1B for a cylindrical vessel), but the mixing vessel includes more than a de minimis portion that is substantially perpendicularly oriented. For example, a substantial side or portion of a sidewall of the vessel may be substantially perpendicularly oriented. The side or portion may be defined vertically with respect to the mixing vessel. In contrast, a curved vessel such as is shown in FIG. 1D may not have a more than a de minimis portion that is substantially perpendicularly oriented. For instance, in one set of embodiments, the mixing vessel has a first portion that is substantially perpendicularly oriented, and a second portion that is not substantially perpendicularly oriented.

One example of such a vessel having a portion that is substantially perpendicularly oriented is shown with reference to FIGS. 3A and 3B, which are top and side views of a non-rotationally-symmetric mixing vessel. FIG. 3A shows the side view of a mixing vessel 10, positioned in a standing position with an open top 16 and a closed base 18, having a first portion 31 that is substantially perpendicular and a second portion 32 that is not substantially perpendicular. In some cases, second portion 32 may include a portion of the vessel that is diametrically opposed to the first portion. The portion “diametrically opposed” to the first portion is that portion furthest away, horizontally, from the first portion. This can be seen more clearly in FIG. 3B, which is a top view of mixing vessel 10 shown in FIG. 3A (i.e., looking down into mixing vessel 10), where second portion 32 is located on the opposite side of the center axis 20 of vessel 10 as first portion 31. In FIG. 3B, center axis 20 runs between the bottom of the vessel 18, where point 27 is located, and the top of the vessel 16, where point 28 is located. Points 27 and 28 are both positioned in the respective centers of the substantially horizontal cross sections of the top and bottom of vessel 10. As can be seen in both FIGS. 3A and 3B, points 27 and 28 are not vertically aligned with respect to each other. However, at first portion 31, the sidewalls of the top and bottom of vessel 10 are vertically aligned with respect to each other; moreover, in this particular example, the sidewalls of all the intervening substantially horizontal cross sections between the top and bottom of vessel 10 are also vertically aligned at first portion 31. In contrast, at second portion 32, diametrically opposed to first portion 31, the sidewalls of the intervening substantially horizontal cross sections between the top and bottom of vessel 10 are not vertically aligned.

As these embodiments also show, when the mixing vessel is in a standing position, the cross-sections of the vessel, when cleaved in a horizontal plane, define circles (although other shapes are possible in other embodiments); thus, only a relatively small portion 31 of the vessel defines a substantially perpendicular portion. Thus, in some embodiments, a substantially perpendicular portion of a mixing vessel may extend from the top of the bottom to the base of the vessel (as is shown in FIGS. 3A-3B, shown with symbol 38), or in other embodiments, the substantially perpendicular portion extends only through a portion of the height of the vessel.

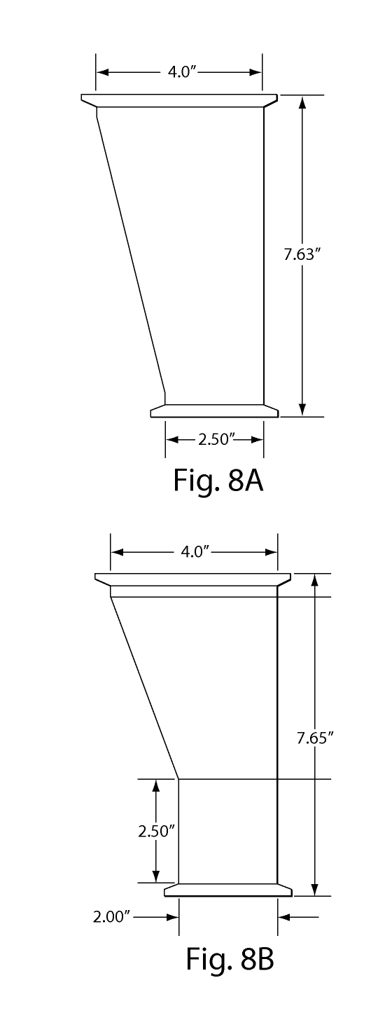

Vessels having substantially perpendicular portions may be useful in some embodiments, although not all vessels discussed herein will have a substantially perpendicular portion. For instance, a vessel having a substantially perpendicular portion may be useful in association with mixers comprising a shaft and one or more blades, paddles, rotors, etc. that extend into the device. The shaft may be extended into the vessel from the top, side, or bottom. In some embodiments, such shafts may be rotated at relatively high speeds. In some cases, the design of the vessel is simplified by using a mixing shaft that substantially perpendicularly descends into the vessel, e.g., parallel to the interior wall or portion that is substantially perpendicularly oriented. Accordingly, in some cases, such shafts will not be able to contact the sidewalls of the mixing vessel. An example is shown in FIG. 3C, where mixing shaft 36, connected to drive (e.g., a motor) 39, descends into vessel 10 in an orientation that is substantially vertically oriented, and parallel to substantially perpendicular portion 31. Thus, the mixing shaft 36 is able to extend into most of the vessel, and blades 33 on mixing shaft 36 can be positioned such that adequate mixing of at least the bottom of vessel 10 can be achieved. Another example of a mixing vessel having a substantially perpendicular portion is shown in FIG. 3D. A specific example can also be seen in FIG. 8A.

In one aspect, the mixing vessel comprises, at least, a first region and a second region, where at least one of these regions is non-rotationally symmetric. The first region and the second region may have the same or different volumes. For example, the second volume may have a volume that is a multiple of the volume of the first region, e.g., with a multiplier of 1, 2, 2.5, 3, 5, 10, 15, 20, 25, 30, etc., or 0.75, 0.5, 0.25, 0.2, 0.1, 0.05, 0.03, 0.01, 0.005, etc. of the volume of the first region. Due to the presence of the non-rotationally symmetric region, the mixing vessel as a whole is also non-rotationally symmetric. The presence of the first region and the second region may be determined in some embodiments as a relatively sharp break in the slope of the sidewalls forming the vessel, e.g., as is shown in FIG. 4A at point 58. However, in some cases, the transition between the first region and the second region may be relatively smooth, with no identifiable sharp break, e.g., as is shown in FIG. 4B.

Such mixing vessels having two or more regions where at least one of the regions is non-rotationally symmetric may be useful, for example, in applications involving the mixing of multiple liquids and/or other fluids. Non-limiting examples of such vessels can be seen with reference to FIG. 4. In FIG. 4A, vessel 10 includes a first region 51, and a second region 52. In this figure, second region 52 is positioned above first region 51, and the two regions together define the interior surface of vessel 10. In other embodiments, however, other geometries are also possible, for example, as is shown in FIG. 4B with first region 51 and second region 52 of mixing vessel 10. Referring again to FIG. 4A, viewing vessel 10 in side profile, i.e., such that the vessel is in a standing position, the separation between first region 51 and second region 52 can be identified as a relatively sharp break or transition in slope at point 58 between first region 51 and second region 52. In this figure, first region 51 has a generally cylindrical shape and is rotationally symmetric, while second region 52 has a non-rotationally-symmetric shape. However, as is shown in FIG. 4B, in other embodiments, there may be no such relatively sharp break or transition in slope between first region 51 and second region 52.

In one embodiment, the use of this vessel is now described with reference to FIGS. 4C-4D. In FIG. 4C, a mixer 29 is present within mixing vessel 10. In this example, mixer 29 includes a rotational shaft 36 extending through most of vessel 10, with blades 33 on mixing shaft 36 being controlled by drive 39. Rotational shaft 36 can be positioned within vessel 10 such that adequate mixing of the bottom of vessel 10 is achieved. Also, as shown in this figure, rotational shaft 36 descends into vessel 10 in a substantially vertically orientation, and parallel to substantially perpendicular portion 31 of mixing vessel 10. It should be noted that in this example, perpendicular portion 31 extends through both first region 51 and second region 52. Additionally, mixing vessel 10 includes a first liquid 55 and a second liquid 56. As shown in this figure, first liquid 55 is substantially immiscible with second liquid 56, and phase separates on the top of second liquid 56. However, it should be understood that this is by way of example only, and in other embodiments, the first and second liquids may be substantially miscible, or mixing may be achieved by rotating mixer 29 before adding the first liquid and/or the second liquid to vessel 10, such that the two liquids are unable to phase separate due to mixing. In some embodiments, mixing by mixer 29 may cause an emulsion of the first and second liquids to form within mixing vessel 10.

Referring now to FIG. 4D, first liquid 55 and second liquid 56 have been emulsified to form emulsion 59. In this figure, emulsion 59 is shown in mixing vessel 10, with third liquid 57 also added to vessel 10. The presence of third liquid 57 within vessel 10 fills the vessel such that liquid is present in both first region 51 and second region 52. As is shown in this figure, third liquid 57 may be immiscible with emulsion 59 and phase separates from emulsion 59 (either the third liquid may be on top, as is shown in this figure, or the emulsion may be on top, depending on their densities, etc.; in still other embodiments, third liquid 57 may be miscible with emulsion 59). In some cases, subsequent mixing of third liquid 57 and emulsion 59 by mixer 29 may be used to create a double emulsion. This process may also be repeated in some cases to form triple or higher order emulsions. It should also be understood that in other embodiments, other fluids or other species may also be present, and/or there may be other actions taken (e.g., heating of the vessel, adding solids or other species, causing chemical reactions to occur within the vessel, adding or removing other fluids from the vessel, etc.) in addition to and/or instead of the ones discussed above.

Yet another example of a non-rotationally symmetric mixing vessel can be seen with reference to FIG. 5, which shows a mixing vessel 10 having a first region 51, a second region 52, and a third region 53. In this example, first region 51 and third region 53 are each rotationally symmetric while second region 52 is non-rotationally symmetric. Thus, mixing vessel 10 in this figure, in its entirety, is also non-rotationally symmetric. Such a vessel may be useful, for example, in mating or welding the top and/or bottom of the vessel to a tank head or other equipment, such as an outlet valve. For instance, a vessel having a non-oblique, circular top region may be useful in connecting or mating the mixing vessel to other process equipment. A specific non-limiting example of such a vessel can be seen in FIG. 8B.

Certain aspects are directed to a mixing apparatus for mixing fluids. In some embodiments, the mixing apparatus includes a mixing vessel able to hold fluids such as liquids. The contents of the mixing vessel can be mixed, for example, using one or more rotational mixers. A rotational mixer may be mounted from the top, side, or bottom of the vessel and at any angle. A rotational mixer may include one or more paddles, blades, rotors (e.g., in a rotor-stator design, where the rotor moves past a stationary element (a “stator”) to cause mixing to occur), and/or other mixer elements, which are rotated in such a fashion as to cause mixing of a fluid contained within the mixing vessel to occur. As is discussed herein, in some embodiments, the rotational mixer may be spun at relatively high speeds, for example, to cause mixing and/or to create high shear rates within a fluid within the mixing vessel. Baffles, stators, or other internal elements may also be present within the mixing vessel in some embodiments to assist in mixing, and such internal elements may be mobile or stationary within the mixing vessel.

Any suitable materials may be mixed within the mixing apparatus. For example, two or more fluids may be mixed together (for example, two or more liquids, a liquid and a gas, etc.), a solid may be mixed with a liquid, or the like. In some cases, one or more fluids and/or other materials may be mixed to create emulsions, solutions, suspensions, or the like. The fluids and/or other materials may be added to the mixing apparatus in any suitable order, e.g., sequentially, simultaneously, etc., and the order of addition of fluids and/or other materials may be a function of the material properties of the fluids and/or other materials in some embodiments.

As discussed below, in some cases, emulsions having relatively small droplets may be formed using such vessels. Such emulsions may be achieved due to the non-rotationally-symmetric interior surface, typically in combination with relatively rapid mixing to create the emulsion. Without wishing to be bound by any theory, it is believed that such emulsions may be achieved because of a reduction in vortexing creating during the relatively rapid mixing used to form the emulsion. For example, an emulsion may comprise a first liquid, present as discrete droplets in a second continuous liquid.

The mixing vessel may be of any suitable shape and size, and the mixing vessel may be formed from any suitable material(s). Non-limiting examples of mixing vessels are described in detail herein. Any number of materials may be added to the mixing vessel to be mixed, and such materials include one or more solids, liquids, gases, etc., in any suitable combination. As a specific non-limiting example, in one set of embodiments, a mixing vessel as discussed herein may be used for mixing fluids together to create emulsions, including double or multiple emulsions. For example, a first fluid and a second fluid may be introduced into a mixing vessel, and mixed to create an emulsion of the first fluid within the second fluid. The first fluid and the second fluid may be substantially immiscible in some cases. As another example, a third fluid may be added to the mixing vessel after the first and second fluids have been emulsified, and these may be mixed to create a double emulsion having child droplets of the first fluid contained within parent droplets of a second fluid, which in turn are carried within a third fluid. In some embodiments, the vessel may be a reducing vessel having varying horizontal cross-sectional areas. Such a vessel may, in some cases, allow the working volume of the first emulsion to be minimized and allow the working height of the vessel when used to create a double emulsion to be minimized.

Certain embodiments are directed to the creation of emulsions, including single emulsions, double emulsions, or higher-order multiple emulsions. As noted above, an emulsion includes a first fluid present as discrete droplets contained within a second, continuous fluid. If the first fluid is itself an emulsion, then a double emulsion may be created, e.g., where the droplets of the first fluid are contained within parent droplets of a second fluid, which in turn are present within a continuous third fluid. This process may be repeated, e.g., to create triple emulsions, quadruple emulsions, etc. Fields in which multiple emulsions may prove useful include, for example, food, beverage, health and beauty aids, paints and coatings, pharmaceuticals, etc.

In some aspects, the fluids may be mixed at relatively high speeds. For example, a rotational apparatus may include a rotational mixer, and a shaft or other portion of the rotational mixer may be spun at relatively high rotational speeds, for example, at speeds of at least about 1,000 RPM (revolutions per minute), at least about 3,000 RPM, at least about 10,000 RPM, at least about 30,000 RPM, or at least about 100,000 RPM, thereby spinning paddles, blades, rotors, or other mixer elements within the mixing vessel, which can cause mixing of fluids to occur. In some cases, a shaft may be spun at relatively high rotational speeds such that the tip speed of the mixer elements is at least about 14 m/s. The “tip speed” of a mixer element is the speed at which the tip of the mixer element moves, where the “tip” is the portion of the mixer element that is positioned farthest away from the axis of rotation, i.e., the portion of the mixer element that experiences the fastest rotational speed during rotation of the mixer element about an axis of rotation, e.g., about a shaft. Typically, the tip will be on the farthest end of a paddle, blade, rotor, or other mixer element. In certain embodiments, the tip speed may be at least about 20 m/s, at least about 25 m/s, at least about 30 m/s, or at least about 40 m/s. In some embodiments, mixing of fluids by a mixer may be used to cause relatively high shear within the fluid being mixed.

The rotational mixer may include a suitable drive able to spin the shaft and/or the mixer elements at such speeds, and many such drives can be commercially obtained. In some cases, the drive may be able to spin a shaft and/or various mixer elements at rotational speeds of at least about 1,000 RPM (revolutions per minute), at least about 3,000 RPM, at least about 10,000 RPM, at least about 30,000 RPM, or at least about 100,000 RPM, etc. The drive may rotate the rotational shaft mechanically, and/or the drive may be a magnetic drive able to cause rotation of a mixer within the vessel to occur. Other systems may be used in other embodiments, e.g., electromagnetic or electric field-based drives. Such systems may be used, for example, in systems where two liquids are to be emulsified, in systems where one or more fluids has a relatively high viscosity, in systems where substantially homogenous mixing is desired, etc.

As discussed, the rotational mixer can include a rotational shaft that is engaged by a driver. The rotational shaft may be made out of any suitable material and may enter the vessel from either the top of the vessel or from underneath the vessel, depending on the embodiment. In some embodiments, however, there may be no rotational shaft present; for example, magnetic and/or electric forces may be used to rotate mixer elements within the vessel. For example, in one embodiment, the mixer element comprises a magnetic stir bar.

Other elements may also be part of the mixing apparatus. For example, in some cases, the mixing apparatus also includes a temperature control system. The temperature control system may partially or completely surround the mixing vessel and/or be within the mixing vessel in some cases. Such temperature control systems may be useful in certain applications where control of temperature within the vessel is desired or required. In some instances, for example, high-speed mixing of fluids within the vessel may cause the fluids to heat, which may in some cases damage the fluids and/or materials within the fluid. Accordingly, to minimize or reduce this problem, the mixing apparatus may further comprise a temperature control system surrounding at least a portion of the vessel. Many such temperature control systems can be readily obtained commercially. Specific examples of temperature control systems include, but are not limited to, fluid jackets such as circulating fluid jackets, resistive heaters, immersion heaters, convective heaters, or the like.

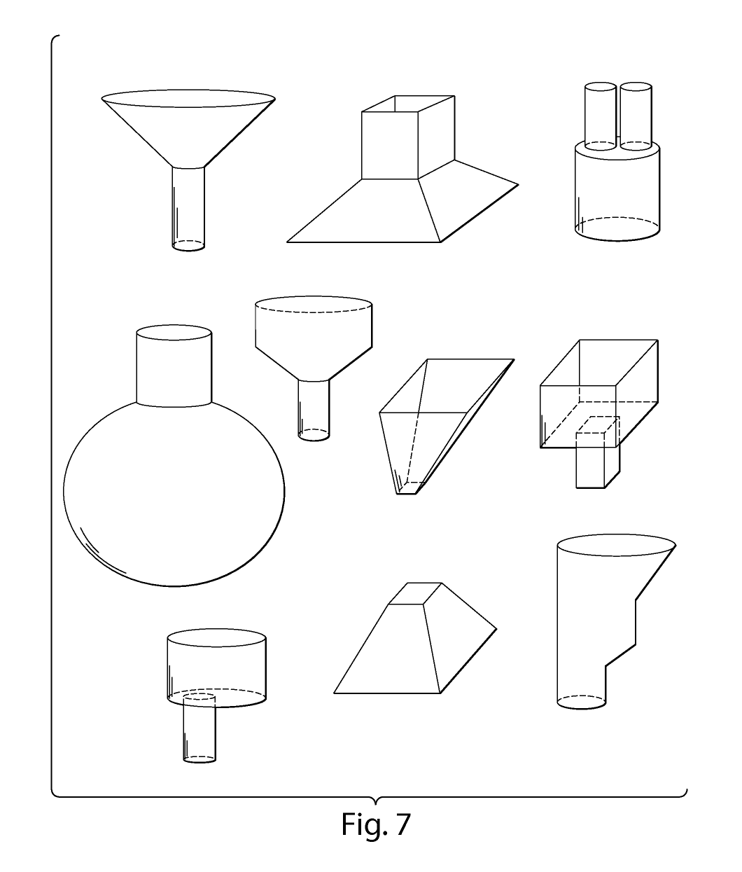

The mixing vessel may be used for batch, semibatch, or continuous processes. In some cases, pipes, tubes, filters, or other fittings may be connected to the vessel, e.g., for the transfer of fluids or other substances into and/or out of the vessel. In some cases, such connections may be connected to the vessel top and/or bottom head as shown in FIG. 6. In this figure, vessel 10 includes a vessel top 72 and a bottom head 74. Vessel top 72 may be used to form a closed vessel, such that access to the interior of the vessel may be achieved using one or more ports, for example, ports 76 and 78 on vessel top 72 and bottom head 74, respectively, as shown in this figure. However, it should be understood that this is by way of example only, and in other embodiments, the vessel may have a vessel top without a bottom head, a bottom head without a vessel top, or neither. There may be zero, one, two, three, or any other suitable number of ports independently present in the vessel top and/or the bottom head. In some cases, such connections may be coupled to the vessel using sanitary tri-clamp fittings as is known by those of ordinary skill in the art. Such connections may be useful, for example, for preserving the cleanliness and/or sterility of the vessel, e.g., for use in the creation of pharmaceuticals.

In some cases, the mixing apparatus may also be used to mix two or more fluids under low-shear conditions. For example, a pre-emulsion may be formed by mixing two or more fluids together, prior to higher speed mixing of the fluids to create an emulsion.

In certain embodiments, the mixing apparatus is used in applications where cleanliness and/or sterility is desired. For example, the mixing apparatus may be used in applications such as food processing or pharmaceutical preparation. In some cases, the interior of the vessel may be sterile. For instance, the vessel may be sterilized with chemicals (e.g., ozone), radiated (for example, with ultraviolet light and/or ionizing radiation), steamed (e.g., an autoclavable vessel), or the like. Appropriate sterilization techniques and protocols are known to those of ordinary skill in the art.

The mixing apparatus may be formed from any suitable material, for example, glass, plastic, a metal (e.g., stainless steel such as 316L stainless steel), etc. In some cases, the vessel may have an inner surface that is substantially smooth and free of cracks, porosity, or joints. The vessel may also have an inner surface that is polished, in some cases. For example, in one set of embodiments, the vessel has an inner surface that is mechanically polished to less than 25 microinch Ra (roughness average) and/or that is electropolished.

In one set of embodiments, particles may be formed from emulsions, such as double emulsions. For example, in a double emulsion comprising child droplets of a first fluid contained within parent droplets of a second fluid, contained within a third fluid, at least some of the fluid from the droplets may be removed or extracted, causing the droplets to solidify to form particles. Extraction of the fluid may be caused, for example, by exposure of child and/or parent droplets to the third fluid, which may cause at least some of the second fluid to be extracted (e.g., via liquid/liquid extraction processes such as partitioning). In some cases, enough fluid may be extracted such that particles are formed. As a specific example, a double emulsion may be prepared where the first fluid comprises an aqueous solution, the second fluid comprises a polymer in methylene chloride, and the third fluid comprises an aqueous solution. Methylene chloride is substantially immiscible in water; however, over time, the methylene chloride may be extracted into the third fluid and evaporated into the surrounding headspace, thereby causing at least some of the droplets of the containing methylene chloride to shrink to form particles. Examples of suitable polymers include, but are not limited to, polylactic acid, polyglycolic acid, poly(lactic-co-glycolic acid), polyethylene glycol, polyanhydrides, polyorthoesters, polyurethanes, polybutyric acid, polyvaleric acid, polylactide-co-caprolactone, polycarbonate, polymethacrylic acid, polyethylenevinyl acetate, polytetrafluorethylene, polymethyl methacrylate, polyacrylic acid, polyesters, or the like.

The following examples are intended to illustrate certain embodiments of the present invention, but do not exemplify the full scope of the invention.

### Example 1

This example illustrates an eccentric vessel used to prepare a double emulsion capable of yielding particles with ova peptide entrapped. A vessel with comparable interior surface as the vessel shown in FIG. 8B was fabricated from 316L stainless steel by Cotter Brothers Corporation (Danvers, Mass.). The vessel was equipped with an open-style heat transfer jacketed with inlet and outlet connections to allow heat transfer fluid to be pumped through the jacket to control the temperature of the fluid inside the vessel. A Polystat temperature control unit (Cole Parmer) was used to recirculate heat transfer fluid through the vessel jacket. A flush-mounted bottom outlet valve was tri-clamped to the bottom of the vessel using a 2 inch tri-clamp (1 inch=2.54 cm). A custom vessel head with tri-clamp ports was tri-clamped to the top of the vessel using a 4 inch tri-clamp. A Polytron PT3100D rotor-stator mixer (Kinematica, Inc.) was inserted through one of the ports in the vessel head.

Ovalbumin peptide was purchased from Bachem Americas Inc. (Torrance Calif.). PLA was purchased from Boehringer Ingelheim Chemicals, Inc. (Petersburg, Va.) and from SurModics Pharmaceuticals (Birmingham, Ala.). PLA-PEG-Nicotine was synthesized in-house. Polyvinyl alcohol used was Baker, product number U232-08. These materials were used to prepare the following solutions:

1. Ovalbumin peptide @ 8 mg/mL in 0.02N hydrochloric acid aqueous solution
2. PLA in methylene chloride @ 100 mg/mL
3. PLA-PEG-nicotine in methylene chloride @ 100 mg/mL
4. Polyvinyl alcohol in aqueous buffer @50 mg/mL

Solution #2 (50 ml) and Solution #3 (50 ml) were charged into the process vessel through one of the ports in the vessel head. Solution #1 was then charged into the process vessel. The geometry of the vessel allowed the solution to sufficiently cover the mixing head of the rotor-stator. The rotor-stator mixer was then run at 27,000 RPM for 20 minutes to create an emulsion. During the mixing the temperature control unit maintained the vessel jacket between 1-4° C., which resulted in a fluid temperature between 12 and 15° C.

The rotor-stator was stopped and Solution #4 (200 ml) was charged into the vessel through one of the ports on the vessel head. The rotor-stator was re-started and run at 18,000 RPM for 25 minutes to create a double emulsion. After 25 minutes, the rotor stator was shut off and particles were formed from the double emulsion by evaporating the methylene chloride. During the mixing the temperature control unit maintained the vessel jacket between 0-5° C., which resulted in a fluid temperature between 12 and 23° C.

Analysis of the particles indicated a double emulsion with the desired characteristics was achieved. Analysis showed the polydispersity of the particle size was acceptable and the ova peptide was entrapped by the particles.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A mixing apparatus, comprising:
a vessel having a non-rotationally-symmetric interior surface, at least a portion of the mixing vessel having horizontal cross-sections having varying area;
a rotational mixer positioned within the vessel; and
a drive engaging the rotational mixer, the drive being constructed and arranged to rotate the rotational mixer.

2. The apparatus of claim 1, wherein the vessel comprises a first region and a second region, wherein the first region is rotationally symmetric and the second region is non-rotationally symmetric.

3. The apparatus of claim 2, wherein the vessel further comprises a third region, isolated from the first region, that is rotationally symmetric.

4. The apparatus of claim 2, the first region defining a first volume and the second region defining a second volume, wherein the volume of the second region is at least twice the volume of the first region.

5. The apparatus of claim 2, the first region defining a first volume and the second region defining a second volume, wherein the volume of the second region is at least 2.5× the volume of the first region.

6. The apparatus of claim 1, further comprising a temperature control system surrounding at least a portion of the vessel.

7. The apparatus of claim 1, wherein the vessel has an interior that is sterile.

8. The apparatus of claim 1, wherein the vessel has an inner surface that is mechanically polished to less than 25 microinch Ra (roughness average).

9. The apparatus of claim 1, wherein the vessel has an inner surface that is electropolished.

10. The apparatus of claim 1, wherein the vessel is formed from stainless steel.

11. The apparatus of claim 1, wherein the vessel is formed from 316L stainless steel.

12. The apparatus of claim 1, wherein the vessel has an inner surface that is substantially smooth and free of cracks, porosity, joints, or defects.

13.-19. (canceled)

20. A method, comprising:
mixing a first liquid and a second liquid to form an emulsion in the mixing apparatus of claim 1.

21.-23. (canceled)

24. A method, comprising:
providing a first liquid and a second liquid in the mixing apparatus of claim 1, wherein the first liquid and the second liquid are substantially immiscible;
mixing the first and second liquids to form an emulsion comprising droplets of the first liquid contained within the second liquid; and
extracting at least some of the first liquid from the droplets to cause the droplets to form particles.

25. A mixing apparatus, comprising:
a vessel, substantially horizontal cross sections of the vessel each defining a shape having a center, wherein at least some of the centers are horizontally offset relative to other centers, and wherein at least some of the substantially horizontal cross sections have varying area;
a rotational mixer positioned within the vessel; and
a drive engaging the rotational mixer, the drive being constructed and arranged to rotate the rotational mixer.

26.-33. (canceled)

34. A method, comprising:
mixing a first liquid and a second liquid to form an emulsion in the mixing apparatus of claim 25.

35. A mixing apparatus, comprising:
a vessel having a base and a first portion that is perpendicular to the base, and a second portion diametrically opposed to the first portion that is not perpendicular to the base, at least a portion of the vessel having horizontal cross-sections having varying area;
a rotational mixer positioned within the vessel; and
a drive engaging the rotational mixer, the drive being constructed and arranged to rotate the rotational mixer.

36.-43. (canceled)

44. A method, comprising:
mixing a first liquid and a second liquid to form an emulsion in the mixing apparatus of claim 35.

45. A mixing apparatus, comprising:
a vessel, at least a portion of which has an oblique frustoconical shape;
a rotational mixer positioned within the vessel; and
a drive engaging the rotational mixer, the drive being constructed and arranged to rotate the rotational mixer.

46.-54. (canceled)

55. A method, comprising:
mixing a first liquid and a second liquid to form an emulsion in the mixing apparatus of claim 45.
